(19) United States
(12) Patent Application Publication
(10) Pub. No.: US 2011/0094292 A1
(43) Pub. Date: Apr. 28, 2011

(54) Apparatus for air property measurement

(76) Inventor: Mingsheng Liu, Omaha, NE (US)

(21) Appl. No.: 12/589,335

(22) Filed: Oct. 23, 2009

(51) Int. Cl. G01N 19/10; G05D 22/02

(52) U.S. Cl. 73/29.02; 236/44 C

(57) ABSTRACT

An air property measurement apparatus comprising a probe and controller. The probe houses a plurality of filters, a temperature sensor, a heating element, and an integrated temperature and relative humidity sensor. In one embodiment, air that enters the probe flows through the temperature sensor, heating element, and integrated temperature and relative humidity sensor, then exits through at least one of the plurality of filters. The controller-determines the air/gas property relationships, allows input of actual ambient pressure and/or atmospheric pressure values, and ascertains the dew point using temperature and relative humidity values as measured by the integrated sensor. Air property values are based on the dew point and temperature as measured by the temperature sensor. The apparatus is suitable for but not limited to relative humidity measurements as well as industrial applications where high humidity conditions exist. In HVAC applications the apparatus provides improved economizer and cooling tower control.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Technical Field

Embodiments are generally related to systems and methods for both commercial and industrial heating, ventilation, and air-conditioning (HVAC) systems, and particularly to industrial processes and devices that require air relative humidity, temperature, enthalpy, dew point, and wet bulb measurements.

2. Discussion of Prior Art

Air property measurements involve both direct temperature and relative humidity measurements. Other parameters such as the temperature, enthalpy, dew point, wet bulb, and humidity ratios can be determined based on the measured temperature and relative humidity using established air parameter relationships.

A relative humidity sensor in a HVAC system is frequently exposed to extremely humid conditions. As a result of these conditions, condensation occurs on the probes of the sensor so that the probes become saturated. This condensation and saturation often cause the sensor to malfunction.

Various toxic and corrosive elements are often present in industrial applications. When a relative humidity sensor is implemented under such conditions, toxic gas and other corrosive elements condense on the sensor surface, resulting in sensor malfunction.

Several variations of humidity sensing apparatuses have been proposed. For example, US patent application 20050247107 to Speldrich, et al. (2004), proposes a relative humidity sensor associated with one or more heating elements, wherein a perimeter of the relative humidity sensor is surrounded with a relatively conductive material. A thin substrate material can surround and laminate the heating element, such that the heating element is porous to permit humid air to pass through the heating element and the heating element is assembled slightly offset from a surface of the relative humidity sensor. Air that is saturated with water vapor can then pass through and be heated by the heating element in order to evaporate water droplets associated with the water vapor to thereby reduce relative humidity to a measurable level.

US patent application 20050247106 to Speldrich, et al. (2004), proposes a relative humidity sensor enclosed with a ceramic heater. A relative humidity sensor can be associated with one or more ceramic heating elements configured from a porous material. In general, a perimeter of the relative humidity sensor is surrounded with a relatively conductive material. A resistive material surrounds one or more of the ceramic heating elements, such that air that is saturated with water vapor passes through the porous material of the ceramic heating element(s). Water vapor can therefore be heated by the ceramic heating element(s) in order to evaporate water droplets associated with the water vapor and thereby reduce relative humidity to a measurable level. The porous material of the ceramic heating element(s) can be provided via a plurality of laser drilled holes to create such porosity.

US patent application 20070186619 to Butt, et al. (2006), is a humidity measuring device that includes a housing having a housing interior, a temperature controller thermally engaging the housing, a humidity sensor provided in the housing interior and an inlet conduit and an outlet conduit disposed in fluid communication with the housing interior. A fuel cell system and a method of measuring humidity in a gas stream are also disclosed.

US patent application 20060225488 to Speldrich, et al. (2005), is a humidity sensor for measuring supersaturated water vapor utilizing a mini-heater. The humidity sensing-apparatus and method includes a humidity sensor capable of measuring relative humidity and a heater located about and proximate to the humidity sensor wherein a portion of the heater comprises a material that permits a diffusion of air through the material of the heater. A sensing area is generally formed between the heater and the humidity sensor, wherein the heater provides a heated environment within the sensing area in order to evaporate water droplets that form within the sensing area and reduce relative humidity to a measurable level and measure supersaturated air within the sensing area.

In all the above disclosed prior art, precision temperature control is required. Since relative humidity is strongly dependent on temperature, the air temperature in the measurement cell or void must be controlled at exactly the same temperature as the temperature of the air before it enters that cell or void. When the temperatures are not the same, the relative humidity is lower than the actual relative humidity. For example, if the actual relative humidity is 100% at an air temperature of 70° F., increasing the air temperature to 75° F. will produce a relative humidity sensor reading of 85%.

### BRIEF SUMMARY OF THE INVENTION

The following summary of the invention is provided to facilitate an understanding of some of the innovative features unique to an embodiment of the present invention and is not intended to be a full description. A full appreciation of the various aspects of the invention can be gained by taking the entire specification, claims, drawings, and abstract as a whole.

It is, therefore, one aspect of an embodiment of the present invention to provide for the reliable and accurate measurement of relative humidity from 0-100%. It is another aspect of the present invention to provide in addition to relative humidity reliable and accurate measurements of air parameters such as the temperature, enthalpy, dew point, wet bulb, and humidity ratios.

It is a further aspect of the present invention to provide improved economizer and cooling tower control in HVAC applications through accurate relative humidity and enthalpy measurements.

The aforementioned aspects of the present invention and other objectives and advantages can now be achieved as described herein. In accordance with a first embodiment, the apparatus for air property measurement includes an integrated temperature sensor, a heating element, a temperature sensor, and a control and signal processing device. The apparatus is constructed so that air passes the temperature sensor, heating element, and integrated temperature and relative humidity sensors. The airflow pattern/direction can be created and controlled by mechanical and/or thermal buoyancy forces. The heating element is controlled in order to (1) warm up the air by approximately 5° F., and 2) maintain relative humidity levels at 80% at the integrated sensor location.

The integrated sensor measures temperature and relative humidity. The dew point temperature is determined based on the air property relationship built in the signal processing device. The dew point and temperature sensor determine the relative humidity, enthalpy, humidity ratio, specific volume, wet bulb, and density measurements.

Atmospheric pressure values can be input into the controller of the present invention. The measured air property can be communicated to other devices through either analog or digital means, or through both analog and digital means.

While the systems and methods presented in the prior art are designed specifically to measure relative humidity in conditions with high humidity, the present invention is intended for use in all humidity conditions. It is particularly well-adapted for use in high humidity conditions though. Thus, several advantages of one or more aspects are to provide easier and more reliable control of the thermal environment of the integrated sensor. This enables a highly accurate dew point measurement. Another advantage of one or more aspects is ease of assembly. A further advantage is to provide enthalpy and wet bulb values that users can directly use in AHU enthalpy economizer and optimal chiller plant control.

It is therefore seen that the present invention provides for a substantial improvement over those systems and methods found in the prior art. Other aspects of the invention will become apparent through consideration of the detailed description and accompanying drawings.

### BRIEF DESCRIPTION OF THE SEVERAL VIEWS OF THE DRAWING

FIG. 1 is a schematic diagram of the system of an embodiment of the invention used for air property measurement;

FIG. 2 is a flowchart that depicts the decision-making processes of the control device of the present invention.

### DRAWINGS REFERENCE NUMERALS

100 Probe
101, 102, 103 Filters
104 Temperature Sensor
105 Heating Element
106 Integrated Relative Humidity and Temperature Sensor
107 Insulated Wall
108 Controller
201 Input Module
202 Heat Element Control Module
203 Dew Point Module
204 Air Property Module
205 Output Module

### DETAILED DESCRIPTION OF THE INVENTION

The particular values and configurations discussed in these non-limiting examples can be varied and are cited merely to illustrate an example of at least one embodiment of the present invention and are not intended to limit the scope of the invention. Also, it is understood that the phraseology and terminology used herein is for the purpose of description and should not be regarded as limiting. The use of “including,” “comprising,” and variations thereof herein is meant to encompass the items listed thereafter and equivalents thereof as well as additional items. Unless specified or limited otherwise, the terms “mounted,” “connected to,” “attached to,” and variations thereof are used broadly to encompass both direct and indirect mountings, connections, and supports.

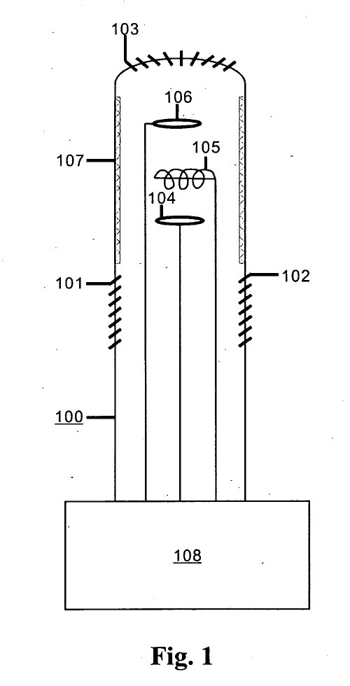

FIG. 1 shown below illustrates one embodiment of the apparatus to include probe (100) and controller (108). Probe (100) is an external encasement housing temperature sensor (104), heater (105), integrated temperature and humidity sensor (106), and insulated wall (107). Probe (100) is attached to controller (108) and faces upward in a horizontal direction. Probe (100) is rotatable so that when inserted into a wall it can be rotated 90 degrees from horizontal to vertical or vertical to horizontal positions, but is not limited to these two positions.

Filters (101) and (102) can be mounted on the opposing sides of probe (100) such that entering air passes through temperature sensor (104). Temperature sensor (104) is located internal to probe (100) and within vicinity of air filters (101) and (102) to measure the true air temperature of entering air.

Entering air flowing upward is warmed by heater (105). The airflow pattern/direction can be created and controlled by mechanical and/or thermal buoyancy forces. Heater (105) is internal to probe (100) and can be located adjacent integrated relative humidity and temperature sensor (106) and within vicinity of temperature sensor (104). Integrated relative humidity and temperature sensor (106) can be located adjacent and upstream heater (105) and measures the temperature and relative humidity at lower than 80%. In an alternative possible embodiment, heater (105) can be integrated as part of integrated temperature and relative humidity sensor (106).

Filter (103) can be mounted on the upper portion of probe (100), allowing a controlled amount of air flow to exit probe (100). Insulated wall (107) provides an insulating layer surrounding the upper portion of the inside of probe (100) to minimize heat loss and input.

Controller (108), mounted to the base of probe (100), receives measured values from temperature sensor (104) and integrated humidity and temperature sensor (106), controls heating element (105), determines the air property values, and then sends those values to other devices through either analog or digital means or both analog and digital means. Controller (108) also allows input of atmospheric pressure values.

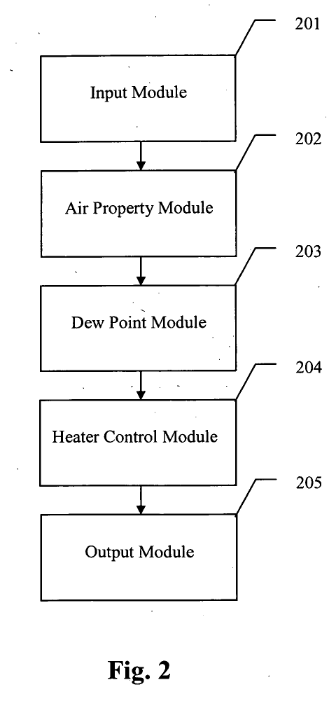

FIG. 2 shown below illustrates the decision making processes of controller (108). Controller (108) includes the following modules for signal processing and control: Input module (201) allows input and/or adjustment of atmospheric and/or ambient pressure values and air/gas element composition values.

Dew point module (203) determines the dew point based on measured relative humidity and temperature values acquired from integrated humidity and temperature sensor (106) and the ambient pressure, air composition, and physical property relationships.

Air property module (204) determines air relative humidity, enthalpy, wet bulb, humidity ratios, specific volume, and/or density, and other parameters as necessary based on the dew point as determined from dew point module (203) and the temperature as measured by integrated temperature and relative humidity sensor (106) as well as ambient/atmospheric pressure, air composition, and air property relationships.

Output module (205) converts and transmits air property values to other apparatuses through either analog or digital means or through both analog and digital means. As an option, display screen can also be used to present the values.

Heater control module (202) modulates heat output by one of the methods described below. However, the following methods are examples, and methods to modulate heat output are thereby not limited to the methods described below:

In one possible method, modulate the heat output of heater (105) to maintain a constant relative humidity level at integrated relative humidity and temperature sensor (106), such as 80%. If the relative humidity is less than 80%, and the output of heater (105) is zero, maintain the output of heater (105) at zero.

In an alternate possible method, modulate the heat output of heater (105) to maintain a constant temperature increase of integrated temperature and relative humidity sensor (106) over temperature sensor (104), such as 5° F. If the temperature reading at integrated temperature and relative humidity sensor (106) is less than 5° F. higher than the temperature reading of temperature sensor (104), maintain the output of heater (105) at zero.

What is claimed is:

1. An apparatus for measuring air property values, the apparatus comprising:
a probe for measuring air property values, wherein said probe houses a plurality of filters, a heating element, a temperature sensor, and an integrated relative humidity and temperature sensor;
a controller configured to receive and send measured air property values collected from said probe, wherein said controller comprises a plurality of modules for signal processing and control of said measured air property values.

2. The apparatus of claim 1, wherein said probe is rotatable.

3. The apparatus of claim 1, wherein said probe is horizontally positioned with respect to said controller.

4. The apparatus of claim 1, wherein said plurality of filters are attached about and approximate to said probe such that said plurality of filters allow air to pass through said probe.

5. The apparatus of claim 4, wherein at least one of said plurality of filters is about and proximate to said upper portion of said probe such that air inside said probe exits through one of said plurality of filters.

6. The apparatus of claim 1, wherein said temperature sensor is situated within said probe such that air passing through said probe also passes said temperature sensor.

7. The apparatus of claim 1, further comprising an insulated wall surrounding the interior of said probe whereby heat input and output through said probe is thereby reduced.

8. The apparatus of claim 1, wherein said heating element is thermally engaging said probe such that air entering said probe is heated by said heating element and flows upstream.

9. The apparatus of claim 1, wherein said integrated relative humidity and temperature sensor is situated within said probe such that air entering said probe passes said integrated relative humidity and temperature sensor.

10. The apparatus of claim 1, wherein said heating element is integrated as part of said integrated temperature and relative humidity sensor.

11. The apparatus of claim 1, wherein said integrated relative humidity and temperature sensor measures the temperature and relative humidity at less than a predetermined maximum value.

12. The apparatus of claim 1, wherein said plurality of modules of said controller further comprises:
an input module configured to input air measurement values;
a dew point module configured to determine the dew point based on measured relative humidity and temperature values from said integrated humidity and temperature sensor, ambient pressure, air composition, and other physical property relationships;
an air property module configured to determine the air relative humidity, enthalpy, wet bulb, humidity ratios, specific volume, density, and other parameters based on the dew point;
an output module configured to convert said air property values to other apparatuses through either analog or digital means or through both analog and digital means; and
a heater control module configured to modulate heat output.

13. The apparatus of claim 12, wherein said output module further comprises a display screen for displaying said air property values.

14. The apparatus of claim 12, wherein said heater control module modulates heater output at a constant relative humidity level at said integrated humidity and temperature sensor.

15. The apparatus of claim 12, wherein said heater control module modulates heater output to maintain a constant temperature increase of said integrated temperature and humidity sensor over said integrated sensor.

16. A method for measuring air property values, comprising:
providing a probe capable of taking air property measurements, said probe comprising an integrated humidity and temperature sensor, a heating element, and a temperature sensor;
locating a plurality of filters about and proximate to said probe, said plurality of filters permitting airflow to pass through said probe;
creating a heated environment within said probe, whereby said heated environment routes said airflow upstream through said sensors so that said sensors measure said airflow;
configuring a controller to determine air property values using said air property measurements collected from said sensors, said controller comprising a plurality of modules.

17. The method of claim 14, wherein creating a heated environment further comprises modulating said heating element at a constant temperature increase of said integrated relative humidity and temperature sensor over said temperature sensor;

18. The method of claim 14, wherein creating a heated environment further comprises maintaining constant relative humidity levels at said integrated temperature and relative humidity sensor.

19. The method of claim 14, further comprising configuring a controller to communicate said air property values through either analog or digital means or through both analog and digital means.

20. The method of claim 14, wherein configuring a controller to determine said air property values further comprises inputting or adjusting atmospheric or ambient pressure, dew point, ambient pressure, air composition, and air/gas element composition values.
